(19) United States
(12) Patent Application Publication
(10) Pub. No.: US 2017/0240294 A1
(43) Pub. Date: Aug. 24, 2017

(54) Three-dimensional infrared laser aircraft landing-guiding system with high directivity

(71) Applicants: Min Chen, Arlington, MA (US); ZHEJIANG UNIVERSITY, Hangzhou (CN); UNIVERSITY OF ELECTRONIC SCIENCE AND TECHNOLOGY OF CHINA, Chengdu (CN); TUNGHAI UNIVERSITY, Taichung (CN)

(72) Inventors: Hongsheng Chen, Hangzhou (CN); Zhaoyun Duan, Chengdu (CN); Min Chen, Arlington, MA (US); Tsong-Shin Lim, Taichung (TW)

(21) Appl. No.: 15/504,598

(22) PCT Filed: Apr. 13, 2015
(86) PCT No.: PCT/CN2015/076477

§ 371 Date: Feb. 16, 2017

(30) Foreign Application Priority Data
Aug. 20, 2014 (CN) 201410412578.8

(51) Int. Cl. B64D 45/08; G01S 17/89; G01S 7/499; B64F 1/18

(52) U.S. Cl. CPC B64D 45/08; B64F 1/18; G01S 17/89; G01S 7/499

(57) ABSTRACT

A three-dimensional infrared laser aircraft landing-guiding system with high directivity is described. The system utilizes a highly penetrable and highly directional infrared laser source to generate an optical image via an optical image generating apparatus. The generated optical image involves the information for aircraft landing, and the information covers a large range of flying areas to make the optical image detectable for an aircraft. With the information provided by the optical image, the aircraft can be guided to the best landing path. The infrared laser source is highly directional and can emit a laser light to specific directions, reducing waste of energy, increasing navigation distances, and improving anti-jamming capability.

### CROSS REFERENCE TO RELATED APPLICATION

This application is a national stage application of International application number PCT/CN2015/076477, filed Apr. 13, 2015, titled “Three-dimensional infrared laser aircraft landing-guiding system with high directivity,” which claims the priority benefit of Chinese Patent Application No. 201410412578.8, filed on Aug. 20, 2014, which is hereby incorporated by reference in its entirety.

### TECHNICAL FIELD

This disclosure relates to fields of aerospace engineering, and particularly to a three-dimensional infrared laser aircraft landing-guiding system with high directivity.

### BACKGROUND

With the help of navigation instrument instructions or ground radio equipment (such as radar, radio direction-finder station, etc.), several kinds of landing-guiding systems have been developed to assist pilots to land an aircraft rightly and safely on an airstrip in complicated weather conditions. According to different weather conditions, three levels of blind landing have been defined: ILS CAT I requires airstrip visibility no less than 800 meters, ILS CAT II requires airstrip visibility no less than 350 meters, and ILS CAT III requires airstrip visibility no less than 210 meters. Currently, two mainstream landing-guiding systems are ILS (Instrument Landing System) and MLS (Microwave Landing System).

ILS is the current standard landing-guiding system admitted by ICAO, equipped by at least thousands of military and civil airports over the world. ILC mainly provides aircraft with a fixed landing path and the minimum channel deviation, and meanwhile, displays 2 or 3 distance checkpoint to ensure landing safety.

MLS mainly provides landing aircraft with flexible terminal arrival guiding, flare out guiding and wave-off guiding, cooperated with DME/P to satisfy the landing ILS CAT III requirements and guarantee the safety.

ILS has the following deficiencies. A single ILS shows low instruction accuracy to satisfy ILS CAT III. ILS uses few radio channels (standards for 40), which will not satisfy the increasing traffic in the future and the growing demand of airstrips quantity will extend the take-off and landing time. ILS coverage antenna beam is easily disturbed when irrelative aircrafts cross by. Due to the narrow approach sector coverage, aircraft can only approach through the center line, which increases difficulty of judgment for pilot and weaken the motor performance. Limited by metric wave bandwidth resources, the instruction accuracy is easily affected by the nearby frequency radio. The performance is restricted by the terrain around the airport and weather such as the snow, which reflects radio waves.

As listed above, current ILS has been gradually losing its satisfaction from the great demand for modern air transportation, and there are great demands to develop a new generation of the landing-guiding system. On the other hand, although MLS was developed as an advanced system to solve the deficiencies of ILS, MLS is too expensive to be popularized, especially at small airports. Facing such deficiencies of ILS and MLS, developing a new generation of the landing-guiding system is necessary. The new system is expected to be low-cost and make small changes on ILS for great improvement on its performance which contrasted with or even taking the place of ILS or MLS for safely landing aircraft in extreme weather conditions.

An infrared laser light at 3˜5 μm and 8˜12 μm has high penetration rate in the air, as well as long transmission distance, which is very suitable to be the landing-guiding source for aircraft. In above techniques, infrared LED is mentioned as the light source for landing guide of aircraft. Nevertheless, the source is at near infrared frequency, which shows low penetration rate. Moreover, LED source has a high divergence angle, while most of the light is scattered in other directions irrelevant to the landing guiding, which limits the method of using LED as a landing-guiding light source.

As an improvement, an infrared laser light in mid-infrared wavelength with high directivity and low divergence is used, which emits an infrared laser light accurately toward the guiding direction while restrain its divergence angle, providing a wider working range and better energy utilization rate than a LED source. The mid-infrared band and far-infrared band commercial laser sources have been available for purchase, in which wavelength infrared laser detecting system is for sell as well. Therefore, by integrating the above relevant available equipment, the present three-dimensional infrared laser aircraft landing-guiding system with high directivity is designed to achieve the practical application of the required functions.

### SUMMARY

Implementations of the disclosure place an infrared laser source with high directivity at the end of the airstrip, which emits an infrared laser light toward the best landing path. The infrared laser light passes through the image generating apparatus and generates an image near the best landing path. The shape and size of the image provide three-dimensional direction information, while this information is detected and recognized by the infrared detecting system and image recognizing system on the aircraft to generate a feedback signal to the pilot or autopilot for safely landing.

In the present disclosure, the light source is selected to be a mid-infrared band or a far-infrared band laser because the specific infrared light has a particularly high transmittance in the air and can be less affected by the weather. The current use of infrared light as the aircraft takeoff and landing guidance system devices are the use of highly divergent light source, while mainly concentrated in the near-infrared range, which makes energy use efficiency to be very low and shortens the navigation distance. Therefore, the disclosure uses a high-directivity mid-infrared or far-infrared laser as a light source, and the laser emits navigation information only in a specific direction, which can reduce the energy waste and increase the navigation distance.

The three-dimensional infrared laser aircraft landing-guiding system with high directivity includes an infrared laser source emitting an infrared laser light toward the best landing path with a low divergence angle, an optical image generating apparatus, which the infrared laser light passes through and generates an image projected toward the best landing path, an infrared detecting system and an image recognizing and analyzing system configured on the aircraft. The infrared laser light passes through the image generating apparatus and generates an image in space, and then the image is projected toward the best landing path. The image is detected by the infrared detecting system and then recognized and analyzed by the image recognizing and analyzing the system to generate a feedback signal. The feedback signal is used for safely landing the aircraft.

The infrared laser source is placed on the airstrip under the best landing site to emit the infrared laser light toward the best landing angle. The wavelength region of the infrared laser light is between 3˜5 μm or 8˜12 μm, and the infrared laser source is the polarized light source. The direction of infrared laser light is calibrated by a visible laser light beam. The infrared laser and visible calibration beam are integrated together by the optical device. In good weather condition, the red and infrared laser are open at the same time, in about 1000 m range, and the pilot can directly look through the red light in the direction of landing. When encountered bad weather, only the infrared laser is open as a guiding light source.

The infrared detecting system can detect a wavelength region between 3˜5 μm or 8˜12 μm. The image recognizing and analyzing system can recognize and analyze image detected by infrared detecting system and display the analysis results. The pilot wears a pair of goggles whose polarization is orthogonal to the polarization of the infrared laser light, preventing pilot's eyes from infrared laser light.

By utilizing the three-dimensional high-directivity infrared light aircraft landing-guiding system, the infrared laser light passes through the image generating apparatus to create an image provides the information for aircraft landing towards the best landing path. The GPS guides the aircraft flying near to the landing airport. The image is detected by the infrared detecting system placed on the aircraft. The detected image is recognized and analyzed by the image recognizing and analyzing system, displaying the analysis results. According to the analysis results from the image recognizing and analyzing system, the pilot or the autonomous flight system may adjust aircraft flying direction to the best landing path.

### BRIEF DESCRIPTION OF THE DRAWINGS

FIG. 1 shows a schematic diagram of a three-dimensional high-directivity infrared light aircraft landing guidance system according to an example of the present disclosure. 1: an airstrip; 2: an infrared laser source with high directivity (low divergence angle); 3: calibrate laser emitters; 4: an optical device; 5: an optical image generating apparatus; 6: infrared detecting system, image recognizing system, and analyzing system that are configured on the aircraft.

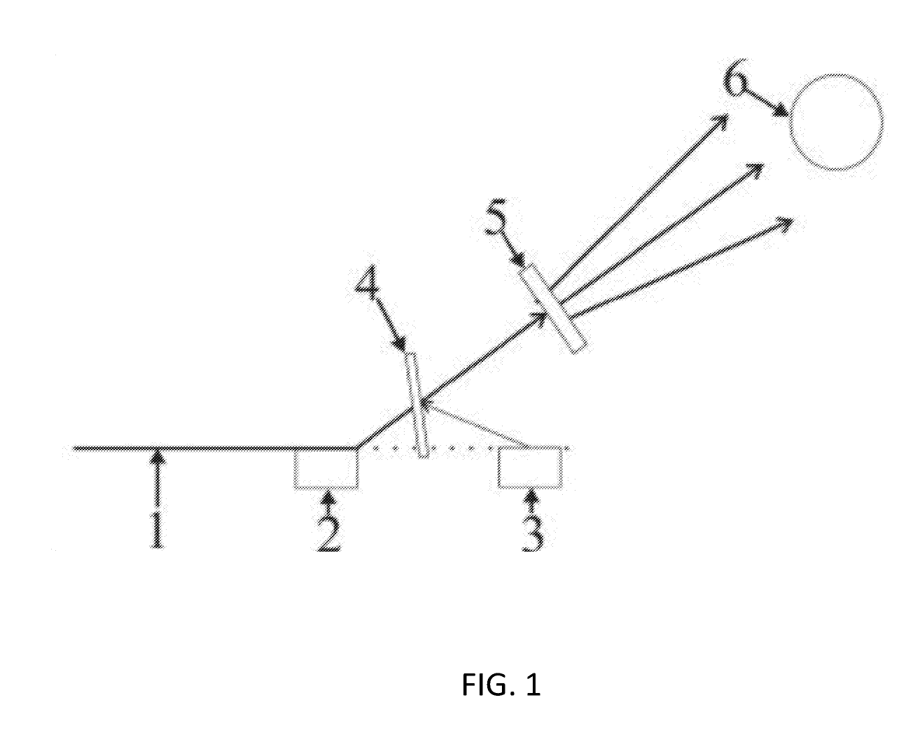

### DETAILED DESCRIPTION OF THE PREFERRED EMBODIMENTS

The three-dimensional high-directivity infrared light aircraft landing guidance system include: an infrared laser source emitting an infrared laser light toward a best landing path with a low divergence angle, a light source for emitting a visible alignment beam, an optical device for converting the infrared laser and the visible alignment beam, an optical image generating apparatus, which the infrared laser light passes through and generates an image projected toward the best landing path, an infrared detecting system and an image recognizing and analyzing system that are configured on the aircraft. An optical image with directional radiation is generated by the laser to provide the information for the pilot to land the aircraft.

The infrared laser source is placed on the airstrip under the best landing site to emit the infrared laser light toward the best landing angle. The wavelength region of the infrared laser light is between 3˜5 μm or 8˜12 μm, and the infrared laser source is the polarized light source. The direction of infrared laser light is calibrated by a visible laser light beam. The calibration beam is a red-light beam. The infrared laser and visible calibration beam are integrated together by the optical device with half-transparency and half-reflection. In a good weather condition, the red and infrared laser are open at the same time, in about 1000 m range, and the pilot can directly look through the red light in the direction of landing. When encountered bad weather, only the infrared laser is open as a guiding light source.

Laser light emitted by an infrared laser source can produce an optical image of directional radiation in the air passing through the image generating apparatus, which can provide the information required for aircraft landing.

The infrared detecting system can detect a wavelength region between 3˜5 μm or 8˜12 μm, and can analyze the optical image changes within two-dimensional plane and time. The image recognizing and analyzing system can recognize and analyze image detected by infrared detecting system and display the analysis results. The pilot wears a pair of goggles whose polarization is orthogonal to the polarization of the infrared laser light, preventing pilot's eyes from infrared laser light.

By utilizing the aforementioned three-dimensional high-directivity infrared light aircraft landing-guiding system, The infrared laser light passes through the image generating apparatus to create an image provides the information for aircraft landing towards the best landing path. A guiding system guides the aircraft flying near to the landing airport; the image is detected by the infrared detecting system placed on the aircraft; the detected image is recognized and analyzed by the image recognizing and analyzing system, displaying the analysis results; according to the analysis results from the image recognizing and analyzing system, the pilot or the autonomous flight system may adjust aircraft flying direction to the best landing path.

According to the present disclosure, an infrared laser source with high penetrability and high directivity is used to transmit the navigation signal only in a specific direction, thereby reducing the energy consumption, covering a larger flight range, increasing the navigation distance, and providing information for aircraft landing. Therefore, the present disclosure can be applied to various types of large and small airports as a landing-guiding assistance system under severe weather conditions and even as a primary landing-guiding system instead of the original landing-guiding system.

What is claimed is:

1. A system for three-dimensional infrared laser aircraft landing-guiding with high directivity, the system comprising:
an infrared laser source emitting a low-divergence infrared laser light based on a best landing angle;
an optical image generating apparatus enabling the laser light to generate a directional radiation of an optical image; and
an infrared detecting system and an image recognizing and analyzing system that are configured on an aircraft.

2. The system in claim 1, wherein a wavelength region of the infrared laser light is between 3˜5 μm or 8˜12 μm.

3. The system of claim 1, wherein the infrared laser source is a polarized light source.

4. The system of claim 1, wherein the infrared laser source is placed on an airstrip under a best landing site such as to emit the infrared laser light based on the best landing angle.

5. The system of claim 1, wherein the optical image provides information including a relative position to the best landing angle and a relative velocity between the aircraft and an airstrip.

6. The system of claim 1, wherein the infrared detecting system detects a wavelength region between 3˜5 μm or 8˜12 μm.

7. The system mentioned in claim 6, wherein the image recognizing and analyzing system recognizes and analyzes image detected by the infrared detecting system as well as displays analysis results.

8. A method of aircraft landing-guiding using the system of claim 1, the method comprising:
(1) guiding an aircraft to fly to a place near to a landing airport using a guiding system;
(2) providing, via an optical system based on a best landing path, an infrared laser light configured to generate an optical image including information for the aircraft to land the landing airport;
(3) detecting, by an infrared detecting system placed on the aircraft, the optical image generated via an optical apparatus;
(4) recognizing and analyzing the optical image by an image recognizing and analyzing system, as well as displaying analysis results; and
(5) adjusting a flying direction of the aircraft based on the analysis results to the best landing path by a pilot or an autonomous flight system.

9. The system in claim 2, wherein a direction of the infrared laser light is calibrated by a visible laser light beam.

10. The system in claim 2, wherein a pilot of the aircraft wears a pair of goggles of which polarization is orthogonal to polarization of the infrared laser light, preventing pilot's eyes from infrared laser light, and the infrared laser source is placed on an airstrip under a best landing site such as to emit the infrared laser light based on the best landing angle.
